(19) United States
(12) Patent Application Publication
(10) Pub. No.: US 2002/0055982 A1
(43) Pub. Date: May 9, 2002

(54) Controlled server loading using L4 dispatching

(75) Inventor: Steve Goddard, Lincoln, NE (US)

Correspondence Address: SENNIGER POWERS LEAVITT AND ROEDEL, ONE METROPOLITAN SQUARE, 16TH FLOOR, ST LOUIS, MO, 63102, US

(73) Assignee: The Board of Regents of the University of Nebraska

(21) Appl. No.: 09/965,526

(22) Filed: Sep. 26, 2001

Related U.S. Application Data
(63) Continuation-in-part of application No. 09/930,014, filed on Aug. 15, 2001.
(60) Provisional application No. 60/245,788, filed on Nov. 3, 2000.
(60) Provisional application No. 60/245,789, filed on Nov. 3, 2000.
(60) Provisional application No. 60/245,790, filed on Nov. 3, 2000.
(60) Provisional application No. 60/245,859, filed on Nov. 3, 2000.

(51) Int. Cl. G06F 15/16

(52) U.S. Cl. 709/217; 709/219

(57) ABSTRACT

Standalone and cluster-based servers, including Web servers, control the amount of data processed concurrently by such servers to thereby control server operating performance. A dispatcher is preferably interposed between clients and one or more back-end servers, and preferably monitors the performance of each back-end server (either directly or otherwise). For each back-end server, the dispatcher preferably also controls, in response to the monitored performance, either or both the number of concurrently processed data requests and the number of concurrently supported connections to thereby control the back-end servers' performance. In one embodiment, the dispatcher uses a packet capture library for capturing packets at OSI layer 2 and implements a simplified TCP/IP protocol in user-space (vs. kernel space) to reduce data copying. Commercially off-the-shelf (COTS) hardware and operating system software are preferably employed to take advantage of their price-to-performance ratio.

### CROSS-REFERENCE TO RELATED APPLICATIONS

This is a continuation-in-part of U.S. application Ser. No. 09/930,014, filed Aug. 15, 2001, now pending, which claims the benefit of U.S. Provisional Application No. 60/245,788, U.S. Provisional Application No. 60/245,789, U.S. Provisional Application No. 60/245,790, and U.S. Provisional Application No. 60/245,859, each filed Nov. 3, 2000. The entire disclosures of the aforementioned applications, and U.S. application Ser. No. 09/878,787, filed Jun. 11, 2001, are incorporated herein by reference.

### FIELD OF THE INVENTION

The present invention relates generally to controlled loading of servers, including standalone and cluster-based Web servers, to thereby increase server performance. More particularly, the invention relates to methods for controlling the amount of data processed concurrently by such servers, as well as to servers and server software embodying such methods.

### BACKGROUND OF THE INVENTION

A variety of Web servers are known in the art for serving the needs of the over 100 million Internet users. Most of these Web servers provide an upper bound on the number of concurrent connections they support. For instance, a particular Web server may support a maximum of 256 concurrent connections. Thus, if such a server is supporting 255 concurrent connections when a new connection request is received, the new request will typically be granted. Furthermore, most servers attempt to process all data requests received over such connections (or as many as possible) simultaneously. In the case of HTTP/1.0 connections, where only one data request is associated with each connection, a server supporting a maximum of 256 concurrent connections may attempt to process as many as 256 data requests simultaneously. In the case of HTTP/1.1 connections, where multiple data requests per connection are permitted, such a server may attempt to process in excess of 256 data requests concurrently.

The same is true for most cluster-based Web servers, where a pool of servers are tied together to act as a single unit, typically in conjunction with a dispatcher that shares or balances the load across the server pool. Each server in the pool (also referred to as a back-end server) typically supports some maximum number of concurrent connections, which may be the same as or different than the maximum number of connections supported by other servers in the pool. Thus, each back-end server may continue to establish additional connections (with the dispatcher or with clients directly, depending on the implementation) upon request until its maximum number of connections is reached.

The operating performance of a server at any given time is a function of, among other things, the amount of data processed concurrently by the server, including the number of connections supported and the number of data requests serviced. As recognized by the inventor hereof, what is needed is a means for dynamically managing the number of connections supported concurrently by a particular server, and/or the number of data requests processed concurrently, in such a manner as to improve the operating performance of the server.

Additionally, most cluster-based servers that act as relaying front-ends (where a dispatcher accepts each client request as its own and then forwards it to one of the servers in the pool) create and destroy connections between the dispatcher and back-end servers as connections between the dispatcher and clients are established and destroyed. That is, the state of the art is to maintain a one-to-one mapping of back-end connections to front-end connections. As recognized by the inventor hereof, however, this can create needless server overhead, especially for short TCP connections including those common to HTTP/1.0.

### SUMMARY OF THE INVENTION

In order to solve these and other needs in the art, the inventor has succeeded at designing standalone and cluster-based servers, including Web servers, which control the amount of data processed concurrently by such servers to thereby control server operating performance. As recognized by the inventor, it is often possible to increase one or more performance metrics for a server (e.g., server throughput) by decreasing the number of concurrently processed data requests and/or the number of concurrently supported connections. A dispatcher is preferably interposed between clients and one or more back-end servers, and preferably monitors the performance of each back-end server (either directly or otherwise). For each back-end server, the dispatcher preferably also controls, in response to the monitored performance, either or both of the number of concurrently processed data requests and the number of concurrently supported connections to thereby control the back-end servers' performance. In one embodiment, the dispatcher uses a packet capture library for capturing packets at OSI layer 2 and implements a simplified TCP/IP protocol in user-space (vs. kernel space) to reduce data copying. Commercially off-the-shelf (COTS) hardware and operating system software are preferably employed to take advantage of their price-to-performance ratio.

In accordance with one aspect of the present invention, a server for providing data to clients includes an OSI layer 4 dispatcher having a queue for storing connection requests received from clients, and at least one back-end server. The dispatcher stores in the queue one or more of the connection requests received from clients when the back-end server is unavailable to process the one or more connection requests. The dispatcher retrieves the one or more connection requests from the queue for forwarding to the back-end server when the back-end server becomes available to process the one or more connection requests. The dispatcher also determines whether the back-end server is available to process the one or more connection requests by comparing a number of connections concurrently supported by the back-end server to a maximum number of concurrent connections that the back-end server is permitted to support, where this maximum number is less than a maximum number of connections which the back-end server is capable of supporting concurrently.

In accordance with another aspect of the present invention, a method for controlled server loading includes receiving a plurality of connection requests from clients, establishing, in response to some of the connection requests, a number of concurrent connections between a server and clients, and storing at least one of the connection requests until one of the established connections is terminated.

In accordance with a further aspect of the present invention, a method for controlled server loading includes defining a maximum number of concurrent connections that a server is permitted to support, monitoring the server's performance, and dynamically adjusting the maximum number in response to the monitoring to thereby adjust the server's performance.

In accordance with still another aspect of the present invention, a method is provided for controlled loading of a cluster-based server having a dispatcher and a plurality of back-end servers. The method includes receiving at the dispatcher a plurality of connection requests from clients, forwarding a plurality of the connection requests to each of the back-end servers, each back-end server establishing a number of concurrent connections with clients in response to the connection requests forwarded thereto, and storing at the dispatcher at least one of the connection requests until one of the concurrent connections is terminated.

In accordance with a further aspect of the invention, a method is provided for controlled loading of a cluster-based server having a dispatcher and a plurality of back-end servers. The method includes defining, for each back-end server, a maximum number of concurrent connections that can be supported, monitoring the performance of each back-end server, and dynamically adjusting the maximum number for at least one of the back-end servers in response to the monitoring to thereby adjust the performance of the cluster-based server.

In accordance with still another aspect of the present invention, a computer-readable medium has computer-executable instructions for implementing any one or more of the servers and methods described herein.

Other aspects and features of the present invention will be in part apparent and in part pointed out hereinafter.

### BRIEF DESCRIPTION OF THE DRAWINGS

FIG. 1 is a block diagram of a server having an L7/3 dispatcher according to one embodiment of the present invention.

FIG. 2 is a block diagram of a cluster-based server having an L7/3 dispatcher according to another embodiment of the present invention.

FIG. 3 is a block diagram of a server having an L4/3 dispatcher according to a further embodiment of the present invention.

FIG. 4 is a block diagram of a cluster-based server having an L4/3 dispatcher according to yet another embodiment of the present invention.

Corresponding reference characters indicate corresponding features throughout the several views of the drawings.

### DETAILED DESCRIPTION OF PREFERRED EMBODIMENTS

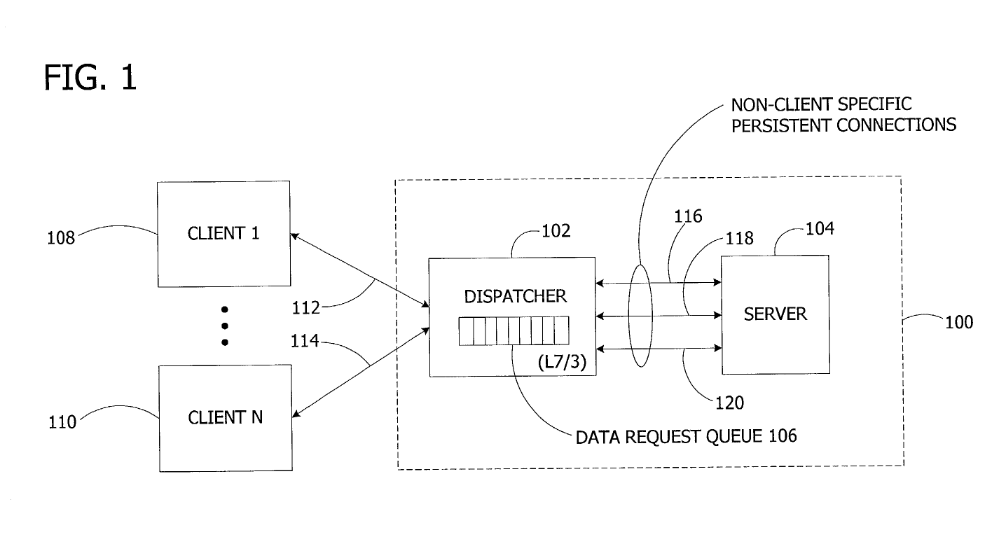

A Web server according to one preferred embodiment of the present invention is illustrated in FIG. 1 and indicated generally by reference character 100. As shown in FIG. 1, the server 100 includes a dispatcher 102 and a back-end server 104 (the phrase “back-end server” does not require server 100 to be a cluster-based server). In this particular embodiment, the dispatcher 102 is configured to support open systems integration (OSI) layer seven (L7) switching (also known as content-based routing), and includes a queue 106 for storing data requests (e.g., HTTP requests) received from exemplary clients 108, 110, as further explained below. Preferably, the dispatcher 102 is transparent to both the clients 108, 110 and the back-end server 104. That is, the clients perceive the dispatcher as a server, and the back-end server perceives the dispatcher as one or more clients.

The dispatcher 102 preferably maintains a front-end connection 112, 114 with each client 108, 110, and a dynamic set of persistent back-end connections 116, 118, 120 with the back-end server 104. The back-end connections 116-120 are persistent in the sense that the dispatcher 102 can forward multiple data requests to the back-end server 104 over the same connection. Also, the dispatcher can preferably forward data requests received from different clients to the back-end server 104 over the same connection, when desirable. This is in contrast to using client-specific back-end connections, as is done for example in prior art L7/3 cluster-based servers. As a result, back-end connection overhead is markedly reduced. Alternatively, non-persistent and/or client-specific back-end connections may be employed. The set of back-end connections 116-120 is dynamic in the sense that the number of connections, maintained between the dispatcher 102 and the back-end server 104 may change over time, including while the server 100 is in use.

The front-end connections 112, 114 may be established using HTTP/1.0, HTTP/1.1 or any other suitable protocol, and may or may not be persistent.

Each back-end connection 116-120 preferably remains open until terminated by the back-end server 104 when no data request is received over that connection within a certain amount of time (e.g., as defined by HTTP/1.1), or until terminated by the dispatcher 102 as necessary to adjust the performance of the back-end server 104, as further explained below.

The back-end connections 116-120 are initially established using the HTTP/1.1 protocol (or any other protocol supporting persistent connections) either before or after the front-end connections 112-114 are established. For example, the dispatcher may initially define and establish a default number of persistent connections to the back-end server before, and in anticipation of, establishing the front-end connections. This default number is typically less than the maximum number of connections that can be supported concurrently by the back-end server 104 (e.g., if the back-end server can support up to 256 concurrent connections, the default number may be five, ten, one hundred, etc., depending on the application). Preferably, this default number represents the number of connections that the back-end server 104 can readily support while yielding good performance. It should therefore be apparent that the default number of permissible connections selected for any given back-end server will depend upon that server's hardware and/or software configuration, and may also depend upon the particular performance metric (e.g., request rate, average response time, maximum response time, throughput, etc.) to be controlled, as discussed further below. Alternatively, the dispatcher 102 may establish the back-end connections on an as-needed basis (i.e., as data requests are received from clients) until the default (or subsequently adjusted) number of permissible connections for the back-end server 104 is established. When a back-end connection is terminated by the back-end server, the dispatcher may establish another back-end connection immediately, or when needed.

According to the present invention, the performance of a server may be enhanced by limiting the amount of data processed by that server at any given time. For example, by limiting the number of data requests processed concurrently by a server, it is possible to reduce the average response time and increase server throughput. Thus, in the embodiment under discussion, the dispatcher 102 is configured to establish connections with clients and accept data requests therefrom to the fullest extent possible while, at the same time, limit the number of data requests processed by the back-end server 104 concurrently. In the event that the dispatcher 102 receives a greater number of data requests than what the back-end server 104 can process efficiently (as determined with reference to a performance metric for the back-end server), the excess data requests are preferably stored in the queue 106.

Once a data request is forwarded by the dispatcher 102 over a particular back-end connection, the dispatcher will preferably not forward another data request over that same connection until it receives a response to the previously forwarded data request. In this manner, the maximum number of data requests processed by the back-end server 104 at any given time can be controlled by dynamically controlling the number of back-end connections 116-120. Limiting the number of concurrently processed data requests prevents thrashing of server resources by the back-end server's operating system, which could otherwise degrade performance.

A back-end connection over which a data request has been forwarded, and for which a response is pending, may be referred to as an “active connection.” A back-end connection over which no data request has as yet been forwarded, or over which no response is pending, may be referred to as an “idle connection.”

Data requests arriving from clients at the dispatcher 102 are forwarded to the back-end server 104 for processing as soon as possible and, in this embodiment, in the same order that such data requests arrived at the dispatcher. Upon receiving a data request from a client, the dispatcher 102 selects an idle connection for forwarding that data request to the back-end server 104. When no idle connection is available, data requests received from clients are stored in the queue 106. Thereafter, each time an idle connection is detected, a data request is retrieved from the queue 106, preferably on a FIFO basis, and forwarded over the formerly idle (now active) connection. Alternatively, the system may be configured such that all data requests are first queued, and then dequeued as soon as possible (which may be immediately) for forwarding to the back-end server 104 over an idle connection. After receiving a response to a data request from the back-end server 104, the dispatcher 102 forwards the response to the corresponding client.

Client connections are preferably processed by the dispatcher 102 on a first come, first served (FCFS) basis. When the number of data requests stored in the queue 106 exceeds a defined threshold, the dispatcher preferably denies additional connection requests (e.g., TCP requests) received from clients (e.g., by sending an RST to each such client). In this manner, the dispatcher 102 ensures that already established front-end connections 112, 114 are serviced before requests for new front-end connections are accepted. When the number of data requests stored in the queue 106 is below a defined threshold, the dispatcher may establish additional front-end connections upon request until the maximum number of front-end connections that can be supported by the dispatcher 102 is reached, or until the number of data requests stored in the queue 106 exceeds another defined threshold (which may be the same as or different than the defined threshold first mentioned above).

As noted above, the dispatcher 102 maintains a variable number of persistent connections 116-120 with the back-end server 104. In essence, the dispatcher 102 implements a feedback control system by monitoring a performance metric for the back-end server 104 and then adjusting the number of back-end connections 116-120 as necessary to adjust the performance metric as desired. For example, suppose a primary performance metric of concern for the back-end server 104 is overall throughput. If the monitored throughput falls below a minimum level, the dispatcher 102 may adjust the number of back-end connections 116-120 until the throughput returns to an acceptable level. Whether the number of back-end connections should be increased or decreased to increase server throughput will depend upon the specific configuration and operating conditions of the back-end server 104 in a given application. This decision may also be based on past performance data for the back-end server 104. The dispatcher 102 may also be configured to adjust the number of back-end connections 116-120 so as to control a performance metric for the back-end server 104 other than throughput, such as, for example, average response time, maximum response time, etc. For purposes of stability, the dispatcher 102 is preferably configured to maintain the performance metric of interest within an acceptable range of values, rather than at a single specific value.

In the embodiment under discussion, where all communications with clients 108-110 pass through the dispatcher 102, the dispatcher can independently monitor the performance metric of concern for the back-end server 104. Alternatively, the back-end server may be configured to monitor its performance and provide performance information to the dispatcher.

As should be apparent from the description above, the dispatcher 102 may immediately increase the number of back-end connections 116-120 as desired (until the maximum number of connections which the back-end server is capable of supporting is reached). To decrease the number of back-end connections, the dispatcher 102 preferably waits until a connection becomes idle before terminating that connection (in contrast to terminating an active connection over which a response to a data request is pending).

The dispatcher 102 and the back-end server 104 may be implemented as separate components, as shown illustratively in FIG. 1. Alternatively, they may be integrated in a single computer device having at least one processor. For example, the dispatcher functionality may be integrated into a conventional Web server (having sufficient resources) for the purpose of enhancing server performance. In one particular implementation of this embodiment, the server 100 achieved nearly three times the performance, measured in terms of HTTP request rate, of a conventional Web server.

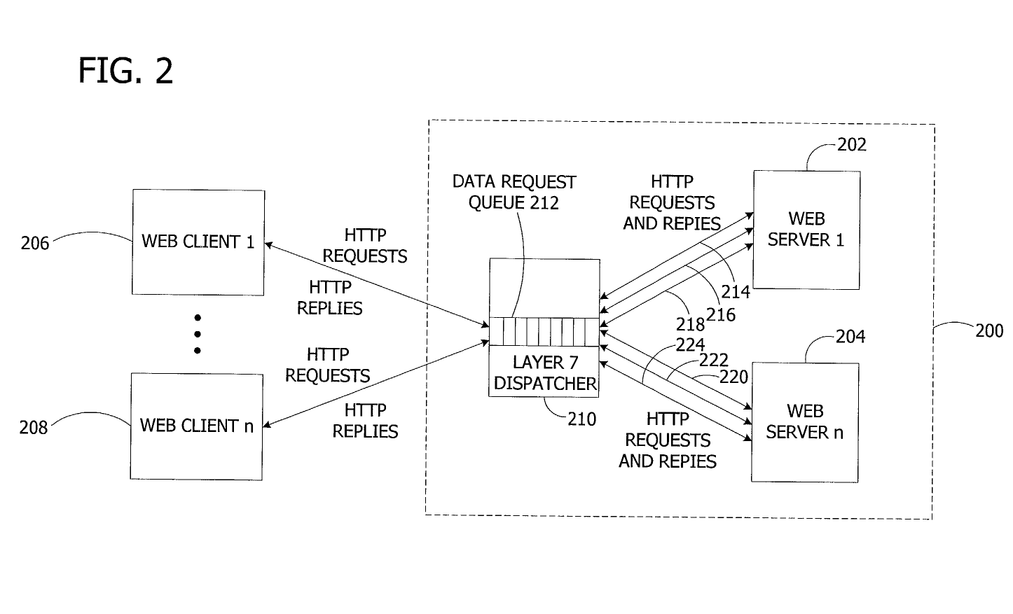

A cluster-based server 200 according to another preferred embodiment of the present invention is shown in FIG. 2, and is preferably implemented in a manner similar to the embodiment described above with reference to FIG. 1, except as noted below. As shown in FIG. 2, the cluster-based server 200 employs multiple back-end servers 202, 204 for processing data requests provided by exemplary clients 206, 208 through an L7 dispatcher 210 having a queue 212. The dispatcher 210 preferably manages a dynamic set of persistent back end connections 214-218, 220-224 with each back-end server 202, 204, respectively. The dispatcher 210 also controls the number of data requests processed concurrently by each back-end server at any given time in such a manner as to improve the performance of each back-end server and, thus, the cluster-based server 200.

As in the embodiment of FIG. 1, the dispatcher 210 preferably refrains from forwarding a data request to one of the back-end servers 202-204 over a particular connection until the dispatcher 210 receives a response to a prior data request forwarded over the same particular connection (if applicable). As a result, the dispatcher 210 can control the maximum number of data requests processed by any back-end server at any given time simply by dynamically controlling the number of back-end connections 214-224.

While only two back-end servers 202, 204 and two exemplary clients 206, 208 are shown in FIG. 2, those skilled in the art will recognize that additional back-end servers may be employed, and additional clients supported, without departing from the scope of the invention. Likewise, although FIG. 2 illustrates the dispatcher 210 as having three persistent connections 214-218, 220-224 with each back-end server 202, 204, it should be apparent from the description below that the set of persistent connections between the dispatcher and each back-end server may include more or less than three connections at any given time, and the number of persistent connections in any given set may differ at any time from that of another set.

The default number of permissible connections initially selected for any given back-end server will depend upon that server's hardware and/or software configuration, and may also depend upon the particular performance metric (e.g., request rate, throughput, average response time, maximum response time, etc.) to be controlled for that back-end server. Preferably, the same performance metric is controlled for each back-end server.

An “idle server” refers to a back-end server having one or more idle connections, or to which an additional connection can be established by the dispatcher without exceeding the default (or subsequently adjusted) number of permissible connections for that back-end server.

Upon receiving a data request from a client, the dispatcher preferably selects an idle server, if available, and then forwards the data request to the selected server. If no idle server is available, the data request is stored in the queue 212. Thereafter, each time an idle connection is detected, a data request is retrieved from the queue 212, preferably on a FIFO basis, and forwarded over the formerly idle (now active) connection. Alternatively, the system may be configured such that all data requests are first queued and then dequeued as soon as possible (which may be immediately) for forwarding to an idle server.

To the extent that multiple idle servers exist at any given time, the dispatcher preferably forwards data requests to these idle servers on a round-robin basis. Alternatively, the dispatcher can forward data requests to the idle servers according to another load sharing algorithm, or according to the content of such data requests (i.e., content-based dispatching). Upon receiving a response from a back-end server to which a data request was dispatched, the dispatcher forwards the response to the corresponding client.

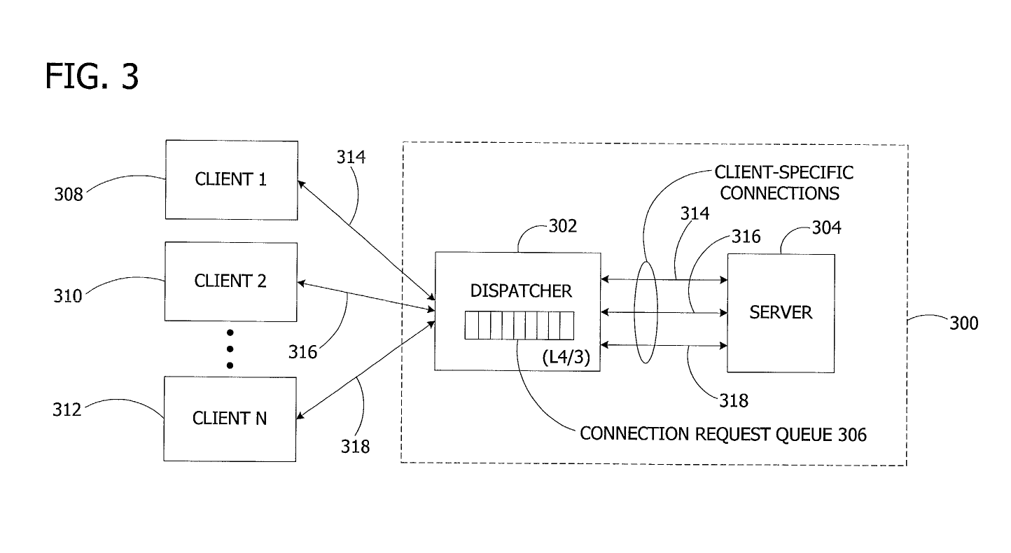

A Web server according to another preferred embodiment of the present invention is illustrated in FIG. 3 and indicated generally by reference character 300. Similar to the server 100 of FIG. 1, the server 300 of FIG. 3 includes a dispatcher 302 and a back-end server 304. However, in this particular embodiment, the dispatcher 302 is configured to support open systems integration (OSI) layer four (L4) switching. Thus, connections 314-318 are made between exemplary clients 308-312 and the back-end server 304 directly rather than with the dispatcher 302. The dispatcher 302 includes a queue 306 for storing connection requests (e.g., SYN packets) received from clients 308-312.

Similar to other preferred embodiments described above, the dispatcher 302 monitors a performance metric for the back-end server 304 and controls the number of connections 314-318 established between the back-end server 304 and clients 308-312 to thereby control the back-end server's performance. Preferably, the dispatcher 302 is an L4/3 dispatcher (i.e., it implements layer 4 switching with layer 3 packet forwarding), thereby requiring all transmissions between the back-end server 304 and clients 308-312 to pass through the dispatcher. As a result, the dispatcher 302 can monitor the back-end server's performance directly. Alternatively, the dispatcher can monitor the back-end server's performance via performance data provided to the dispatcher by the back-end server, or otherwise.

The dispatcher 302 monitors a performance metric for the back-end server 304 (e.g., average response time, maximum response time, server packet throughput, etc.) and then dynamically adjusts the number of concurrent connections to the back-end server 304 as necessary to adjust the performance metric as desired. The number of connections is dynamically adjusted by controlling the number of connection requests (e.g., SYN packets), received by the dispatcher 302 from clients 308-312, that are forwarded to the back-end server 304.

Once a default number of connections 314-318 are established between the back-end server 304 and clients 308-312, additional connection requests received at the dispatcher 302 are preferably stored in the queue 306 until one of the existing connections 314-318 is terminated. At that time, a stored connection request can be retrieved from the queue 306, preferably on a FIFO basis, and forwarded to the back-end server 304 (assuming the dispatcher has not reduced the number of permissible connections to the back-end server). The back-end server 304 will then establish a connection with the corresponding client and process data requests received over that connection.

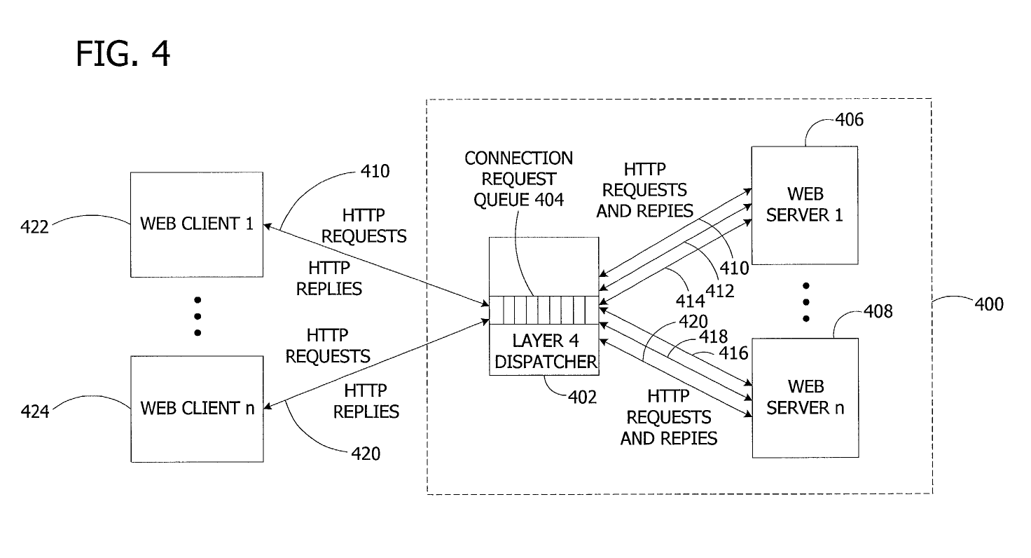

FIG. 4 illustrates a cluster-based embodiment of the Web server 300 shown in FIG. 3. As shown in FIG. 4, a cluster-based server 400 includes an L4/3 dispatcher 402 having a queue 404 for storing connection requests, and several back-end servers 406, 408. As in the embodiment of FIG. 3, connections 410-420 are made between exemplary clients 422, 424 and the back-end servers 406, 408 directly. The dispatcher 402 preferably monitors the performance of each back-end server 406, 408 and dynamically adjusts the number of connections therewith, by controlling the number of connection requests forwarded to each back-end server, to thereby control their performance.

While the present invention has been described primarily in a Web server context, it should be understood that the teachings of the invention are not so limited, and are applicable to other server applications as well.

When introducing elements of the present invention or the preferred embodiment(s) thereof, the articles “a”, “an”, “the” and “said” are intended to mean that there are one or more such elements. The terms “comprising”, “including” and “having” are intended to be inclusive and mean that there may be additional elements other than those listed.

As various changes could be made in the above constructions without departing from the scope of the invention, it is intended that all matter contained in the above description or shown in the accompanying drawings shall be interpreted as illustrative and not in a limiting sense.

What is claimed is:

1. A server for providing data to clients, the server comprising:
an OSI layer 4 dispatcher having a queue for storing connection requests received from clients; and
at least one back-end server;
wherein the dispatcher stores in the queue one or more of the connection requests received from clients when the back-end server is unavailable to process said one or more connection requests;
wherein the dispatcher retrieves said one or more connection requests from the queue for forwarding to the back-end server when the back-end server becomes available to process said one or more connection requests; and
wherein the dispatcher determines whether the back-end server is available to process said one or more connection requests by comparing a number of connections concurrently supported by the back-end server to a maximum number of concurrent connections that the back-end server is permitted to support, the maximum number being less than a maximum number of connections which the back-end server is capable of supporting concurrently.

2. The server of claim 1 wherein the dispatcher is configured to monitor a performance of the back-end server, to define the maximum number of concurrent connections that the back-end server is permitted to support, and to dynamically adjust the maximum number in response to the monitored performance.

3. The server of claim 1 wherein the server is a cluster-based server comprising a plurality of back-end servers, wherein the dispatcher is configured to store in the queue said one or more connection requests when none of the back-end servers is available to process said one or more connection requests, and wherein the dispatcher is further configured to retrieve said one or more connection requests from the queue for forwarding to one of the back-end servers when said one of the back-end servers becomes available to process said one or more connection requests.

4. The server of claim 1 wherein the server is a Web server.

5. The server of claim 1 wherein the dispatcher and the back-end server are embodied in COTS hardware.

6. The server of claim 1 wherein the dispatcher comprises a first computer device, wherein the back-end server comprises a second computer device, and wherein the first and second computer devices are configured to communicate with one another over a computer network.

7. A method for controlled server loading, the method comprising:
receiving a plurality of connection requests from clients;
establishing, in response to some of the connection requests, a number of concurrent connections between a server and clients; and
storing at least one of the connection requests until one of the established connections is terminated.

8. The method of claim 7 wherein the number of concurrent connections established between the server and clients is less than a maximum number of connections which the server is capable of supporting concurrently.

9. The method of claim 7 further comprising retrieving the stored connection request after at least one of the established connections is terminated, and establishing a connection between the server and a client associated with the retrieved connection request.

10. The method of claim 7 wherein the storing includes storing a plurality of the connection requests, the method further comprising retrieving one of the stored connection requests and establishing a new connection between the server and a client associated with the retrieved one of the connection requests each time one of the established connections is terminated.

11. The method of claim 10 wherein the retrieving includes retrieving the stored connection requests on a FIFO basis.

12. The method of claim 7 wherein the connection requests are TCP requests.

13. The method of claim 7 wherein at least the receiving and the storing are performed by a single computer device having at least one processor.

14. The method of claim 13 wherein the single computer device comprises the server.

15. A computer-readable medium having computer-executable instructions for performing the method of claim 7.

16. A method for controlled server loading, the method comprising:
defining a maximum number of concurrent connections that a server is permitted to support;
monitoring the server's performance; and
dynamically adjusting the maximum number in response to the monitoring to thereby adjust the server's performance.

17. The method of claim 16 wherein the monitoring includes monitoring the server's performance in terms of a performance metric selected from the group consisting of average response time, maximum response time, and server packet throughput.

18. The method of claim 16 further comprising receiving a plurality of connection requests from clients, establishing in response to some of the connection requests the maximum number of concurrent connections with the server, and storing at least one of the connection requests until one of the established connections is terminated.

19. The method of claim 18 wherein the dynamically adjusting includes dynamically adjusting the maximum number as a function of the number of connection requests that are concurrently stored.

20. The method of claim 19 wherein the dynamically adjusting includes increasing the maximum number when the number of concurrently stored connection requests is greater than a predefined number.

21. The method of claim 19 wherein the dynamically adjusting includes decreasing the maximum number when the number of concurrently stored connection requests is less than a predefined number.

22. A method for controlled loading of a cluster-based server, the cluster-based server including a dispatcher and a plurality of back-end servers, the method comprising:
receiving at the dispatcher a plurality of connection requests from clients;
forwarding a plurality of the connection requests to each of the back-end servers, each back-end server establishing a number of concurrent connections with clients in response to the connection requests forwarded thereto; and
storing at the dispatcher at least one of the connection requests until one of the concurrent connections is terminated.

23. The method of claim 22 wherein the storing includes storing a plurality of the connection requests, and wherein the forwarding includes forwarding one of the stored connection requests to one of the back-end servers each time one of the concurrent connections is terminated.

24. The method of claim 22 wherein the cluster-based server is an L4/3 server.

25. A method for controlled loading of a cluster-based server, the cluster-based server including a dispatcher and a plurality of back-end servers, the method comprising:
defining, for each back-end server, a maximum number of concurrent connections that can be supported;
monitoring the performance of each back-end server; and
dynamically adjusting the maximum number for at least one of the back-end servers in response to the monitoring to thereby adjust the performance of the cluster-based server.

26. The method of claim 25 wherein the dynamically adjusting includes dynamically adjusting the maximum number for each back-end server.

27. The method of claim 25 further comprising receiving a plurality of connection requests from clients, forwarding some of the connection requests to the back-end servers, each back-end server establishing a number of concurrent connections with clients in response to the connection requests forwarded thereto, and storing at least one of the connection requests until one of the concurrent connections is terminated.

28. The method of claim 27 wherein the dynamically adjusting includes dynamically adjusting the maximum number for said one of the back-end servers as a function of the number of connection requests that are concurrently stored.
